(19) United States
(12) Patent Application Publication
(10) Pub. No.: US 2013/0017362 A1
(43) Pub. Date: Jan. 17, 2013

(54) Self-Adhesive Beverage Napkin

(71) Applicants: Serkan Barutcu, Vienna (AT); Adrian Pelkus, Escondido, CA (US)

(72) Inventors: Serkan Barutcu, Vienna (AT); Adrian Pelkus, Escondido, CA (US)

(21) Appl. No.: 13/358,486

(22) Filed: Jan. 25, 2012

Related U.S. Application Data
(60) Provisional application No. 61/435,909, filed on Jan. 25, 2011.

(51) Int. Cl. A47G 11/00; B32B 37/12

(52) U.S. Cl. 428/138; 156/538

(57) ABSTRACT

A self-adhesive napkin for releasably attaching to a beverage container having a plurality of openings formed along an edge of the napkin and a pressure sensitive, single-sided adhesive tape applied to the edge of the outer surface of the napkin containing the plurality of openings. The adhesive surface of the adhesive tape along one edge of the napkin is protected from inadvertent adherence by way of the recesses formed in the napkin from the plurality of openings. Further, for napkins in a uniformly oriented stack conformation, the non-adhesive surface of the adhesive tape functions as a release layer. Application of pressure to the adhesive tape collapses the adhesive surface into and through the plurality of openings for releasably attaching to a target surface.

### CROSS REFERENCES

This application claims priority from U.S. Provisional Patent Application Ser. No. 61/435,909 filed Jan. 25, 2011 incorporated herein in its entirety by this reference.

### FIELD OF INVENTION

The present invention relates generally to a self-adhesive napkin and more particularly, to a beverage napkin with a pressure sensitive adhesive along one edge for releasably attaching to hot or cold beverage containers. The present invention further relates to an apparatus for making the self-adhesive beverage napkin.

### BACKGROUND OF THE INVENTION

Typically, when a patron visits a local restaurant or bar, the patron is served either a hot or cold beverage in a glass, ceramic or other appropriate container of a material suitable for holding liquid beverages. When served the hot or cold beverage, the serviceperson usually will accompany the beverage with a beverage napkin to serve as either a coaster or insulating layer between the patron's hand and the beverage container. A common problem experienced by a patron is the inability to properly grip the hot or cold beverage container due to high temperatures or the formation of condensation on the outside of the beverage container. A patron would prefer to avoid such problems by keeping their hands dry and burn-free.

One common solution to this problem is to take the supplied beverage napkin and wrap it around the outer surface of the beverage container. For a cold beverage, the condensation will provide a means for attaching the napkin to the beverage container. Unfortunately, over time, the napkin may begin to lose structural integrity and its ability to properly adhere to the beverage container. For a hot beverage, the napkin has no means for attaching to the beverage container and thus, the patron must continuously pick up and place the napkin between their hand and the beverage container to obtain the requisite gripping and insulating properties.

To address the problems associated with hot and cold beverages, a number of beverage sleeves or insulated jackets have been devised to overcome the high temperatures and condensation associated with various forms of beverage containers. For example, see U.S. Pat. No. 6,290,091 to Bell, U.S. Pat. No. 4,540,611 to Henderson and U.S. Pat. No. 5,425,497 to Sorenson. Generally, these devices are cumbersome and more costly to manufacture and thus, not a feasible alternative to the ordinary beverage napkin found in the restaurant and bar industries.

Alternatively, adhesive napkins have been devised but exist within the context of dinner napkins or bibs for affixing to the patron's clothing to protect the clothing from food or drink spillage. Generally, these napkins contain an adhesive sufficient for affixing the napkin or bib to the clothing and a release layer in spaced relation on the napkin to the adhesive (or affixed directly to the adhesive) to permit folding of the napkin without sticking to itself. For example, see U.S. Pat. No. 2,803,574 to Payant, U.S. Pat. No. 5,476,697 to Bellander, U.S. Pat. No. 5,552,200 to Gureff and U.S. Pat. No. 6,079,048 to Campbell. None of these adhesive napkins are designed or adaptable to overcome the inherent problems associated with hot or cold beverages.

Thus, a need exists for a self-adhesive beverage napkin adaptable for releasably attaching to a beverage container while providing insulating, absorption and handgrip properties during the consumption of a hot or cold beverage.

It is an object of the present invention to provide a self-adhesive beverage napkin that will releasably affix to the exterior of any beverage container and maintain its adhesive properties throughout the consumption of hot or cold beverages.

It is a further object of the present invention to provide a self-adhesive beverage napkin that will absorb condensation and provide a thermal benefit by minimizing direct contact of the patron's hand with the beverage container.

It is a further object of the present invention to provide a self-adhesive beverage napkin adaptable to accommodate beverage containers of varying shape, sizes and materials.

It is a further object of the present invention to provide a self-adhesive beverage napkin that can be formed from any pliable material including, but not limited to, paper, fabric, cotton, linen, or the like.

It is a further object of the present invention to provide a self-adhesive beverage napkin that will accept printing or embossing.

It is a further object of the present invention to provide a self-adhesive beverage napkin with a releasable layer preventing the self-adhesive beverage napkin from sticking to other like self-adhesive beverage napkins in a stacked conformation.

### BRIEF SUMMARY OF THE INVENTION

The present invention specifically addresses and alleviates the above mentioned deficiencies, more specifically, the present invention is directed to a self-adhesive beverage napkin adaptable to releasably affix to beverage containers of varying shape, size and material. In addition, the self-adhesive beverage napkin will withstand the range of temperatures and, in some cases, the resulting condensation on the surface of beverage containers.

Accordingly, in a first aspect, the present invention provides a napkin comprising a body of flexible material having an inner and an outer surface. The inner surface is in contact with a target surface when the flexible material is detachably affixed thereto. A plurality of openings is located along an edge of the flexible material. An adhesive tape having an adhesive surface and non-adhesive surface is applied along the edge of the outer surface of the flexible material containing the plurality of openings. In this way, the adhesive surface will remain recessed from the inner surface until pressed from the outer surface against the target surface causing the adhesive surface of the adhesive tape to protrude through the plurality of openings from the outer surface to the inner surface and detachably affix the flexible material to the target surface.

In a further aspect, the plurality of openings are circularly shaped and equally spaced along the edge of the flexible material.

In another aspect, the size of the plurality of openings is proportional to the weight of the flexible material.

In yet a further aspect, the non-adhesive surface provides a releasable surface for the napkins in a stacked conformation.

In a further aspect, the non-adhesive surface accepts printing.

In another aspect of the present invention, an apparatus for making the self-adhesive napkin is provided comprising a system controller, a napkin loader, a napkin separator, a conveyor, a punch plate and a tape dispenser.

While the napkin and apparatus for making the napkin have or will be described for the sake of grammatical fluidity with functional explanations, it is to be expressly understood that the claims, unless expressly formulated under 35 USC 112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front view of an exemplary embodiment of a self-adhesive napkin;

FIG. 2 is a rear view of an exemplary embodiment of a self-adhesive napkin;

FIG. 2a is a rear view of an exemplary embodiment of a self-adhesive napkin;

FIG. 3 is a side view of an exemplary embodiment of a self-adhesive napkin;

FIG. 4 is a side view of an exemplary embodiment of a self-adhesive napkin; and

FIG. 5 is a front view of the apparatus for making the self adhesive napkin.

### DETAILED DESCRIPTION OF THE PREFERRED EMBODIMENTS

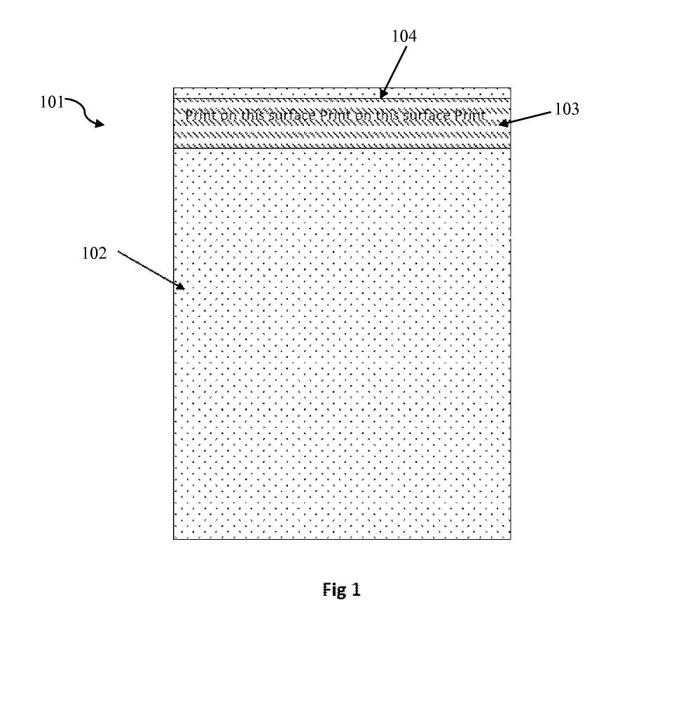

Referring initially to FIG. 1, illustrating a front view of an exemplary embodiment of a self-adhesive napkin showing the napkin 101, the outer surface 102 of the napkin 101 and the non-adhesive surface 103 of an adhesive tape 104 along an edge of the outer surface 1.02 of the napkin 101 and affixed thereto by the adhesive surface 107 (not shown) of the adhesive tape 104. The non-adhesive surface 103 of the adhesive tape accepts printing or embossing of promotional information, logos or messages viewable by patron's when releasably affixed to a beverage container.

The napkin 101 can be made from any flexible material suitable for use as a beverage napkin including, but not limited to, paper, fabric, cotton, linen, or the like.

The adhesive tape can be made from plastic, fabric, cloth or other flexible material evenly coated on one side with a pressure-sensitive adhesive material sufficient for releasably affixing the napkin 101 to the exterior of a beverage container. The adhesive tape should have limited aggressiveness such that the adhesive stays with the adhesive tape and napkin when peeled away leaving the beverage container free from any adhesive residues.

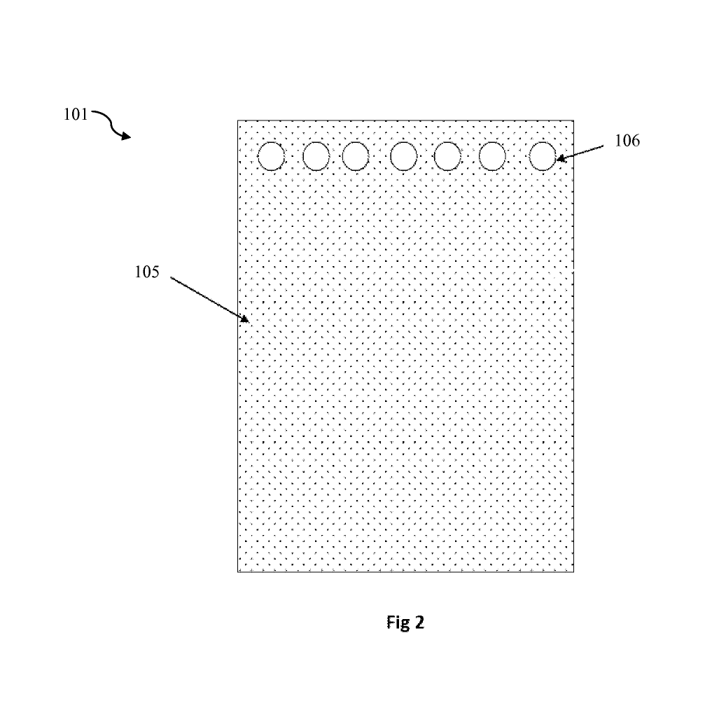

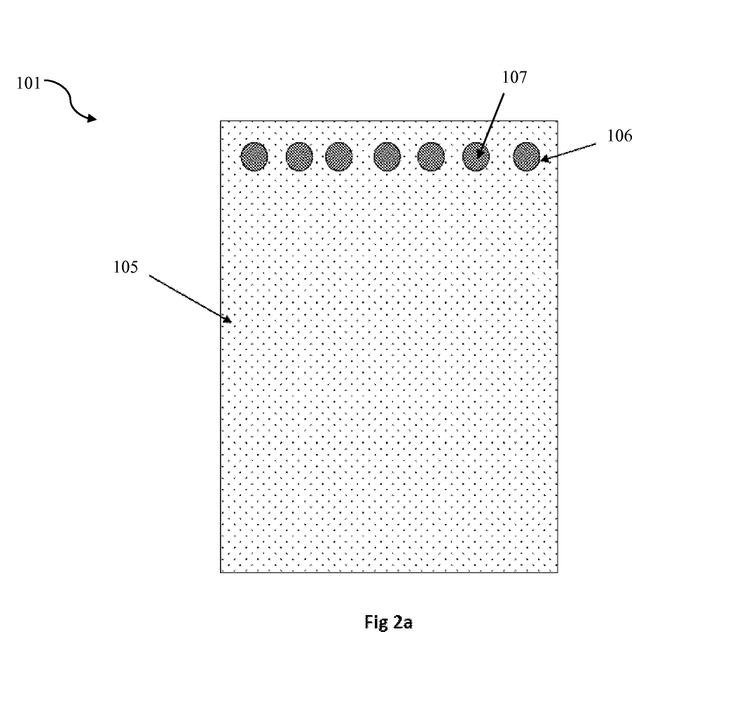

Referring now to FIG. 2, illustrating a rear view of an exemplary embodiment of a self-adhesive napkin showing the napkin 101, the inner surface 105 of the napkin 101 and a plurality of openings 106 formed along an edge of the napkin 101.

The size and spacing of the plurality of openings is adaptable and optimized to accommodate the various target surfaces as well as the various form and materials making up the napkin. For example, the thinner and lighter in weight the napkin, the less surface area of the plurality of openings required to achieve optimal adhesion to the beverage container. The thicker and heavier in weight the napkin, the greater surface area of the plurality of openings required to achieve optimal adhesion to the beverage container.

Referring more particularly to the illustration FIG. 2a is a rear view of an exemplary embodiment of a self-adhesive napkin showing the inner surface 105 of the napkin 101 and the adhesive surface 107 of the adhesive tape 104 (not shown) applied along an edge of the outer surface 102 (not shown) of the napkin 101 and as seen through the plurality of openings 106 formed along an edge of the napkin 101.

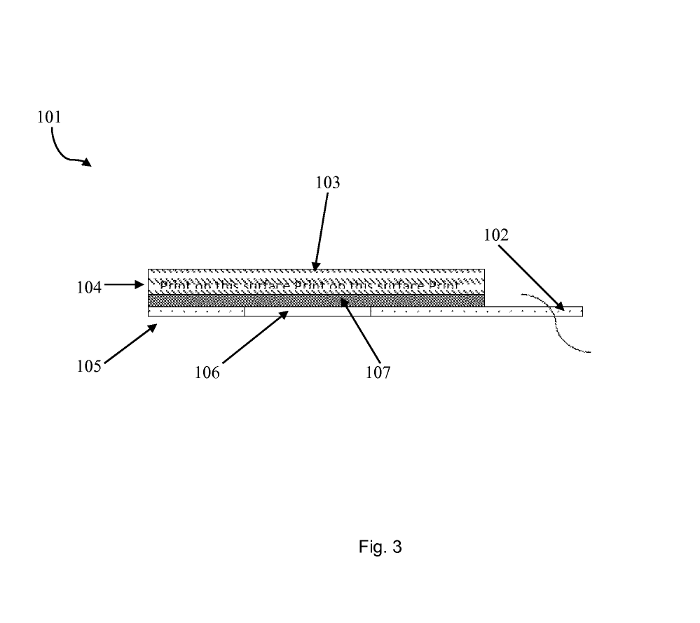

Referring now to FIG. 3, illustrating a side view of a self-adhesive napkin showing the adhesive tape 104 applied to the outer surface 102 of the napkin 101 and affixed thereto by the adhesive surface 107 of the adhesive tape 104. The non-adhesive surface 103 of the adhesive tape 104 is viewable by the patron when affixed to a beverage container. A plurality of openings 106 formed along an edge of the napkin 101 form recesses through which the adhesive surface 107 of the adhesive tape 104 will protrude through when sufficient pressure is applied to releasably affix the napkin 101 to a beverage container (not shown). The inner surface 105 of the napkin 101 will therefore be oriented towards the beverage container.

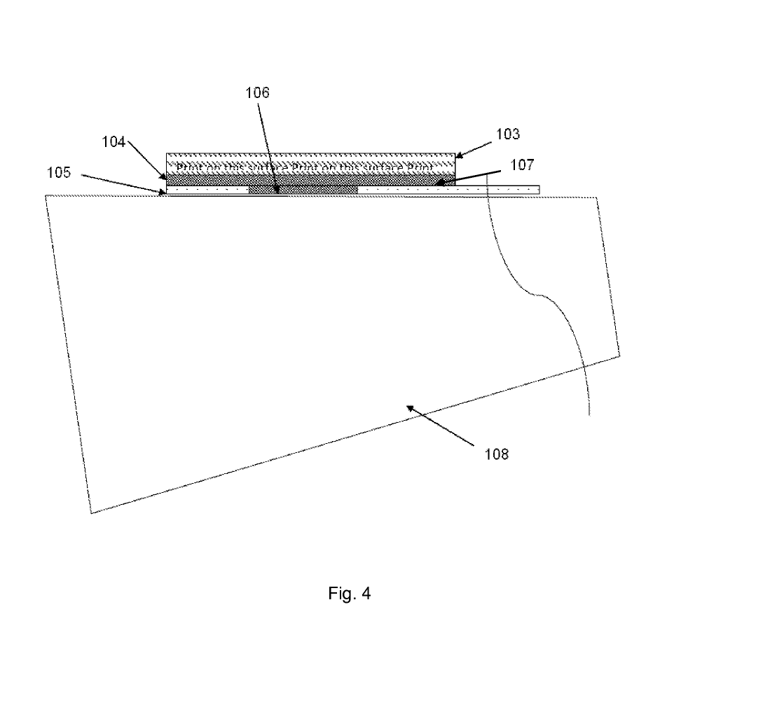

Referring now to FIG. 4, illustrating a side view of a self-adhesive napkin releasably affixed to a beverage container 108 showing the inner surface 105 of the napkin 101 oriented towards the beverage container 108. The napkin 101 is releasbly affixed to the beverage container 108 when sufficient pressure is applied to the non-adhesive surface 103 of the adhesive tape 104. Pressure applied to the non-adhesive surface 103 of the adhesive tape 104 collapses the adhesive surface 107 into the plurality of openings 106 protruding the adhesive surface 107 locally to the inner surface 105 of the napkin 101 enabling contact with the beverage container 108.

The plurality of openings 106 form recesses for the adhesive surface 107 that allow for the napkin 101 to be placed in a stacked conformation without having the napkin 101 irretrievably stick to the next napkin 101 in the stack. In addition, when uniformly oriented, the non-adhesive surface 103 of the adhesive tape 104 will act as a release layer in the event the weight of the napkin 101 in a stacked conformation results in the adhesive surface 107 collapsing into and protruding through the plurality of openings 106.

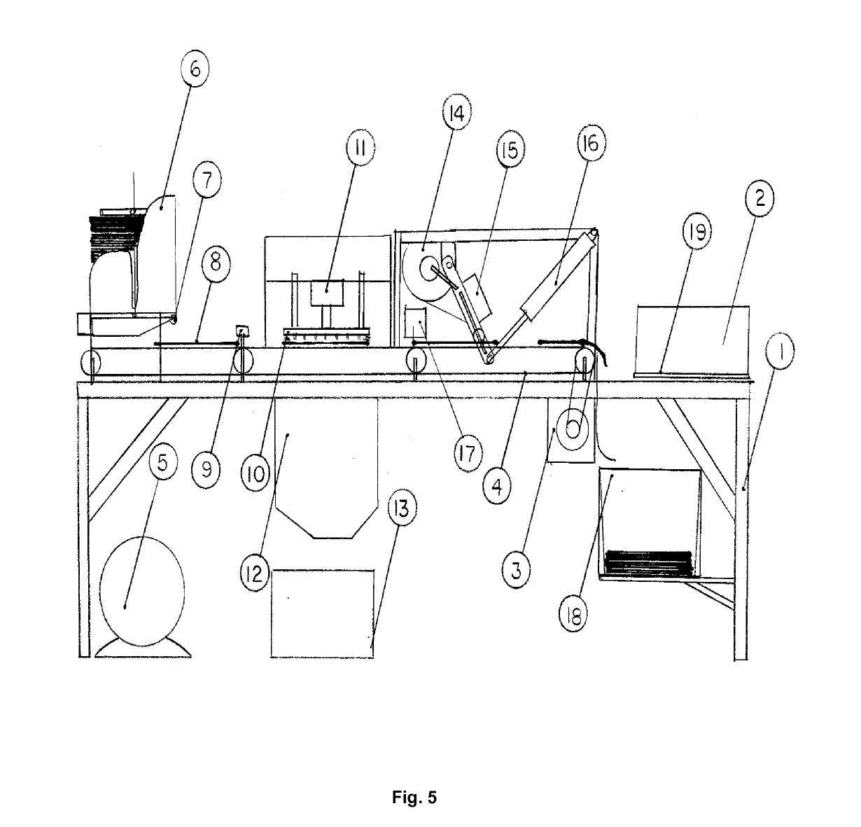

Referring now to FIG. 5, illustrating the apparatus for making the self-adhesive napkin. In the preferred embodiment, the apparatus is an automated punch and tape machine configurable to practically any napkin size or shape as well as practically any tape available on a reel. The automation may be any control system including, but not limited to, a manual numerical control, programmable logic control or any other industrial control system, which may work in concert with other manual or computer-aided applications.

The apparatus may sit on a stable frame 1. The system controller 2 runs the entire machine with Start/Stop control. The machine operates on 110V or 220V electricity and compressed air supplied by a compressor 5.

In operation, a human operator loads napkins in the napkin loader 6. Individual napkins 8 are separated from the stack by a napkin separator 7 and laid on a conveyor belt 4. Photo switches 9 are used to coordinate the machine operation.

Napkins 8 are shuttled on the conveyor 4 and placed under a punch plate 10. Pins on the punch plate are pressed by a compressed air driven punch actuator 11 thru the napkin 8 forming perforations or openings. The excess material from the perforations or openings is scrap that falls down the waste shoot 12 into a waste basket 13.

Napkins 8 are next shuttled on the conveyor 4 to a taping station where tape on reel 14 is dispensed with a dispenser 15 that is driven across the surface of the napkins 8 by a compressed air driven tape actuator 16. At the end of travel, an automatic tape slitter 17 slices the tape at the edge of the napkins 8.

Finished Napkins 8 are shuttled on the conveyor 4 into the finished napkin tray 18. The human operator removes these finished napkins for packaging. Periodic visual inspection of production products by the human operator are performed on the Inspection table 19.

Banding or other packaging can be added to the apparatus by adding additional modules.

While the particular invention herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed. All the publications cited are incorporated herein by reference in their entireties, including all published patents, patent applications, literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and sub generic groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A napkin comprising:
(a) a body of flexible material having an inner and an outer surface such that the inner surface is in contact with a target surface when the flexible material is releasably affixed thereto;
(b) a plurality of openings located along an edge of the flexible material; and
(c) an adhesive tape having an adhesive surface and non-adhesive surface, the adhesive tape applied along the edge of the outer surface of the flexible material containing the plurality of openings such that the adhesive surface will remain recessed from the inner surface until pressed from the outer surface against the target surface causing the adhesive surface of the adhesive tape to protrude through the plurality of openings from the outer surface to the inner surface and detachably affix the flexible material to the target surface.

2. The napkin of claim 1 wherein the plurality of openings are circularly shaped and equally spaced along the edge of the flexible material.

3. The napkin of claim 2 wherein the size of the plurality of openings is proportional to the weight of the flexible material.

4. The napkin of claim 1 wherein the non-adhesive surface provides a releasable surface for the napkins in a stacked conformation.

5. The napkin of claim 4 wherein the non-adhesive surface accepts printing.

6. The napkin of claim 1 wherein the adhesive surface is adaptable for releasably affixing to hot and cold surfaces.

7. The napkin of claim 6 wherein the adhesive surface remains releasably affixed under conditions of condensation.

8. A napkin comprising:
(a) a body of flexible material having an inner and an outer surface such that the inner surface is in contact with a target surface when the flexible material is releasably affixed thereto;
(b) a plurality of openings located along an edge of the flexible material;
(c) a non-adhesive surface providing a releasable surface for the napkins in a stacked conformation; and
(c) an adhesive tape having an adhesive surface and non-adhesive surface, the adhesive tape applied along the edge of the outer surface of the flexible material containing the plurality of openings such that the adhesive surface will remain recessed from the inner surface until pressed from the outer surface against the target surface causing the adhesive surface of the adhesive tape to protrude through the plurality of openings from the outer surface to the inner surface and detachably affix the flexible material to the target surface.

9. The napkin of claim 8 wherein the plurality of openings are circularly shaped and equally spaced along the edge of the flexible material.

10. The napkin of claim 9 wherein the size of the plurality of openings is proportional to the weight of the flexible material.

11. The napkin of claim 8 wherein the non-adhesive surface accepts printing.

12. The napkin of claim 8 wherein the adhesive surface is adaptable for releasably affixing to hot and cold surfaces.

13. The napkin of claim 12 wherein the adhesive surface remains releasably affixed under conditions of condensation.

14. An apparatus for making the napkin of claim 1 comprising:
(a) A system controller;
(b) a napkin loader;
(c) a napkin separator;
(d) a conveyor;
(e) a punch plate; and
(f) a tape dispenser.
